(19) United States
(12) Patent Application Publication
(10) Pub. No.: US 2009/0062974 A1
(43) Pub. Date: Mar. 5, 2009

(54) Autonomous Mobile Robot System

(76) Inventors: Junichi Tamamoto, Kasumigaura (JP); Yuji Hosoda, Kasumigaura (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/196,310

(22) Filed: Aug. 22, 2008

(30) Foreign Application Priority Data
Sep. 3, 2007 (JP) 2007-227812

(51) Int. Cl. G05D 1/00

(52) U.S. Cl. 701/25; 901/1

(57) ABSTRACT

An autonomous mobile robot system having plural mobile robots and integrative planning means to plan the moving zone of the plural mobile robots, wherein: the integrative planning means is installed on the plural mobile robots including a main mobile robot to travel autonomously and a subordinate mobile robot to travel on the basis of the instructions of the main mobile robot; and each of the plural mobile robots is provided with, at least, measurement means to measure the situation of ambient environment, communication means to communicate between the integrative planning means and the other mobile robot, main device position recognition means to recognize the position of the mobile robot, subordinate device position recognition means to recognize the position of the other mobile robot, travel planning means to plan travel routes of the mobile robot and the other mobile robot, and travel control means to control a drive mechanism in accordance with the travel planning means. A guided vehicle and a truck or the like can travel autonomously and cooperatively while obtaining information on ambient environment without mechanical connection and can automatically be separated from and merged with each other.

### BACKGROUND OF THE INVENTION

The present invention relates to a movement system of a mobile object such as a mobile robot, a running vehicle, or the like wherein the mobile object is accompanied by a mobile object other than the main body and autonomously moves while obtaining information on ambient environment.

Examples of the movement system comprising a mobile object as the main body and an accompanying mobile object are the method for connecting and disconnecting an automatic guided vehicle and a loading truck and the system thereof shown in Japanese Patent Application Laid-Open Publication Nos. H10-24836 and H6-107168. A structure of a connectable and disconnectable joint between an automatic guided vehicle and a loading truck is shown in the patent documents. Further, in the conveying system with a conveying convoy shown in Japanese Patent Application Laid-Open Publication No. H6-107168, the combination of an automatic guided vehicle and a towed convoy and a configuration of a towed truck having a steering mechanism are shown.

In the configuration of an aforementioned automatic guided vehicle and a truck towed thereby, the truck is towed by mechanically connecting them to each other. Such a configuration is effective when they move in an unchanged state from the start point to the end point of transportation. When the number of the towed trucks or the convoy changes or they separate or merge in the middle of the start point and the end point of the transportation however, a problem here is that they have to be disconnected and connected mechanically and hence they are hardly automated. Further, another problem is that, since the connection is regulated by mechanical structural conditions, a towed truck is limited to the primarily intended and planned mechanism and shape and it is difficult to adjust the towed truck when the specifications of a conveyed object are changed.

### BRIEF SUMMARY OF HE INVENTION

An object of the present invention is, in view of the above conventional problems, to provide a system and a control method of an autonomous mobile robot that moves autonomously and jointly or moves separately while a guided vehicle and a truck or the like are not mechanically connected and information on ambient environment is obtained.

The present invention is an autonomous mobile robot system having plural mobile robots and integrative planning means to plan the moving zone of the plural mobile robots, wherein: the integrative planning means is installed on the plural mobile robots including a main mobile robot to travel autonomously and a subordinate mobile robot to travel on the basis of the instructions of the main mobile robot; and each of the plural mobile robots is provided with, at least, measurement means to measure the situation of ambient environment, communication means to communicate between the integrative planning means and the other mobile robot, main device position recognition means to recognize the position of the mobile robot, subordinate device position recognition means to recognize the position of the other mobile robot, travel planning means to plan travel routes of the mobile robot and the other mobile robot, and travel control means to control a drive mechanism in accordance with the travel planning means.

Here, the subordinate mobile robot may be designated to be changed to a main mobile robot by the instructions of the integrative planning means and may travel autonomously when the subordinate mobile robot is separated from the interlocked main mobile robot and travels.

Further, when the travel route along which the main mobile robot travels merges with another travel route, the main mobile robot may be designated to be changed to a subordinate mobile robot by the instructions of the integrative planning means and may cooperatively travel after merger by the instructions of another main mobile robot located on the other travel route.

Furthermore, the present invention is a method for controlling plural autonomous mobile robots by integrative planning means to plan the moving zone of the plural mobile robots, wherein: the integrative planning means designates the plural mobile robots as a main mobile robot to travel autonomously and a subordinate mobile robot to travel on the basis of the instructions of the main mobile robot; each of the plural mobile robots recognizes the positions of the mobile robot and the other mobile robot by measuring the situation of ambient environment and plans the travel routes of the mobile robot and the other mobile robot; and the main and subordinate mobile robots cooperatively travel along the travel routes on the basis of the instructions of the main mobile robot designated by the integrative planning means.

Here, the subordinate mobile robot may be designated to be changed to a main mobile robot by the instructions of the integrative planning means and may travel autonomously when the subordinate mobile robot is separated from the interlocked main mobile robot and travels.

By the present invention, a main mobile robot controls a subordinate mobile robot and thereby it is possible to reduce mutual interference during traveling and travel effectively. Further, a main mobile robot and a subordinate mobile robot may be separated and merged automatically and easily. As a result, a subordinate mobile robot once separated can merge with a main mobile robot and travel together and hence it is possible to reduce the frequency of the travel of the robots and enhance safety in travel environment where the robots intersect with a human body such as a worker.

### BRIEF DESCRIPTION OF THE SEVERAL VIEWS OF THE DRAWINGS

FIG. 1 is a schematic diagram of an autonomous mobile robot system according to the present invention;

FIG. 2 is a general configuration diagram showing the first embodiment according to the present invention;

FIG. 3 is a view explaining the coordinates of a main device and a subordinate device according to the first embodiment of the present invention;

FIG. 4 is a view explaining a travel route according to the first embodiment of the present invention;

FIG. 5 is a view explaining diverged traveling according to the first embodiment of the present invention;

FIG. 6 is a view explaining merged traveling according to the first embodiment of the present invention;

FIG. 7 is a general configuration diagram showing the second embodiment according to the present invention;

FIG. 8 is a general configuration diagram showing the third embodiment according to the present invention;

FIG. 9 is a view explaining a method for detecting a subordinate device according to the third embodiment of the present invention;

FIG. 10 is a general configuration diagram showing the fourth embodiment according to the present invention;

FIG. 11 is a general configuration diagram showing the fifth embodiment according to the present invention;

FIG. 12 is a view explaining operations in the first embodiment according to the present invention;

FIG. 13 is a view explaining operations in the second embodiment according to the present invention;

FIG. 14 is a general configuration diagram showing the sixth embodiment according to the present invention;

FIG. 15 is a view explaining operations in the sixth embodiment according to the present invention;

FIG. 16 is another view explaining operations in the sixth embodiment according to the present invention;

FIG. 17 is a general configuration diagram showing the seventh embodiment according to the present invention;

FIG. 18 is a general configuration diagram showing the eighth embodiment according to the present invention; and

FIG. 19 is a view explaining operations in the eighth embodiment according to the present invention.

### DETAILED DESCRIPTION OF THE INVENTION

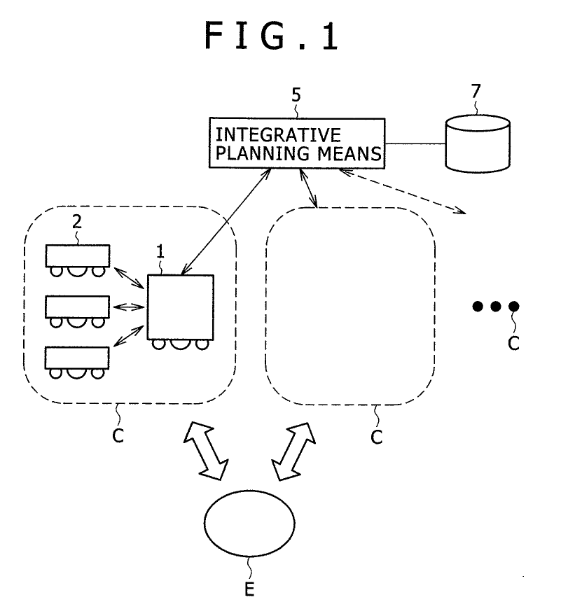

Embodiments according to the present invention are hereunder explained. The concept of an autonomous mobile robot system according to an embodiment of the present invention is shown in FIG. 1. The reference character 1 represents an autonomous mobile robot that can autonomously plan travel routes and autonomously move, 2 represents subordinate mobile robots that receive instructions from the autonomous mobile robot 1 and move together with the autonomous mobile robot 1 or independently, and C represents an autonomous mobile robot group that includes the autonomous mobile robot 1 and the plural subordinate mobile robots 2. The autonomous mobile robot group C moves around production lines in a plant or the like in a row and autonomously conveys necessary parts and semifinished products at prescribed production steps, for example.

The reference character 5 represents integrative planning means that plans and indicates the moving zone of at least one autonomous mobile robot group C. In the present embodiment, the integrative planning means 5 plans travel routes of an autonomous mobile robot group C at a travel node level on the basis of a task database 7. Then the autonomous mobile robot 1 plans travel routes at a track level on the basis of the instructions on the travel routes planned at the travel node level.

On this occasion, the autonomous mobile robot 1 obtains circumstances E varying from hour to hour of the travel routes around production lines in accordance with the traveling and plans the travel routes of the autonomous mobile robot 1 and the subordinate mobile robots 2 at the track level in real time. The travel routes of the subordinate mobile robots 2 at the track level are transmitted from the autonomous mobile robot 1 to the subordinate mobile robots 2 and the traveling of the subordinate mobile robots 2 is controlled.

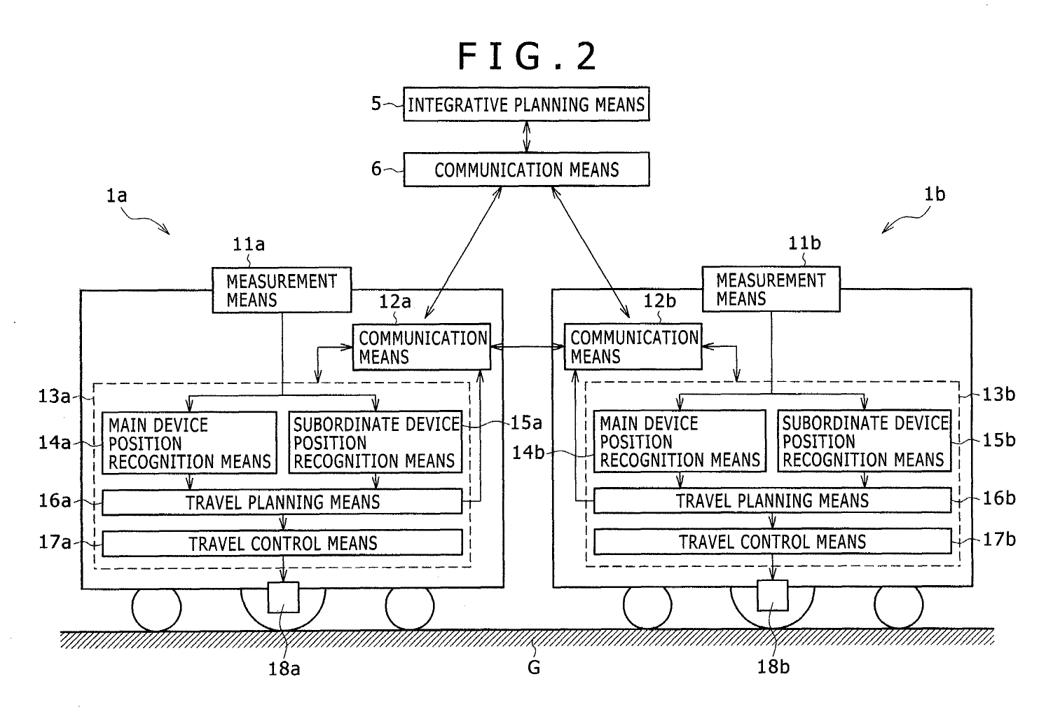

More specific configurations are explained hereunder. FIG. 2 is a general configuration diagram of a robot system using autonomous mobile robots 1 according to the first embodiment of the present invention. In FIG. 2, the reference character 6 represents communication means for wirelessly carrying out communication between the integrative planning means 5 to plan the traveling of the autonomous mobile robots 1 (1a and 1b) and the autonomous mobile robots 1.

The integrative planning means 5 plans the destinations of the plural autonomous mobile robots 1 and travel nodes (at the travel node level) leading to the destinations and instructs the autonomous mobile robots 1 via the communication means 6. Further, when plural autonomous mobile robots 1 are operated in combination, the autonomous mobile robot 1a is designated as a main device and the autonomous mobile robot 1b is designated as a subordinate device, respectively.

An autonomous mobile robot 1 comprises at least the following components. The reference character 11 represents measurement means to measure the position of a physical body and the relative positions of plural autonomous mobile robots 1 as the ambient environment of travel routes and the measurement means 11 is placed at an upper portion of the autonomous mobile robot 1 so as to ensure unobstructed views. The examples of the measurement means 11 are a laser range finder to scan a horizontal plane with laser beams and measure a distance on the basis of the time required for the reflection from a physical body, a CCD stereovision sensor system to measure the distance of an object on the basis of the parallax of plural CCD camera images, and a landmark-used sensor system to take in landmark information such as a two-dimensional bar code or the like attached to a physical body with a CCD sensor and to measure a distance on the basis of the landmark information and the view angle thereof.

The reference character 12 represents communication means to transmit and receive information between the integrative planning means 5 and another autonomous mobile robot 1. The examples are communication means using radio waves such as a wireless LAN or the like and light communication means using infrared light pulses or the like. The reference character 13 surrounded by the broken line represents computation means to compute with a CPU or the like and the computation means 13 contains main device position recognition means 14, subordinate device position recognition means 15, travel planning means 16, and travel control means 17.

The main device position recognition means 14 recognizes the position of the autonomous mobile robot 1 acting as the main device on the basis of the information obtained by the measurement means 11. An example of the method for obtaining information in the measurement means 11 is the technology of generating a map from the distance information of a laser range finder shown in “a device and a method for generating a map image by laser measurement” of Japanese Patent Application Laid-Open Publication No. 2005-326944 and recognizing the position of itself on the map.

In summary, that is a technology of: measuring the orientation and the distance to an obstacle several times by moving a laser distance sensor; extracting a feature point by histogram from an image being obtained by the measurements and showing the position of the obstacle; and generating a map by superimposing the images having feature points most coinciding with each other. Here, the main device position recognition means 14a recognizes the position of the autonomous mobile robot 1a itself designated as the main device.

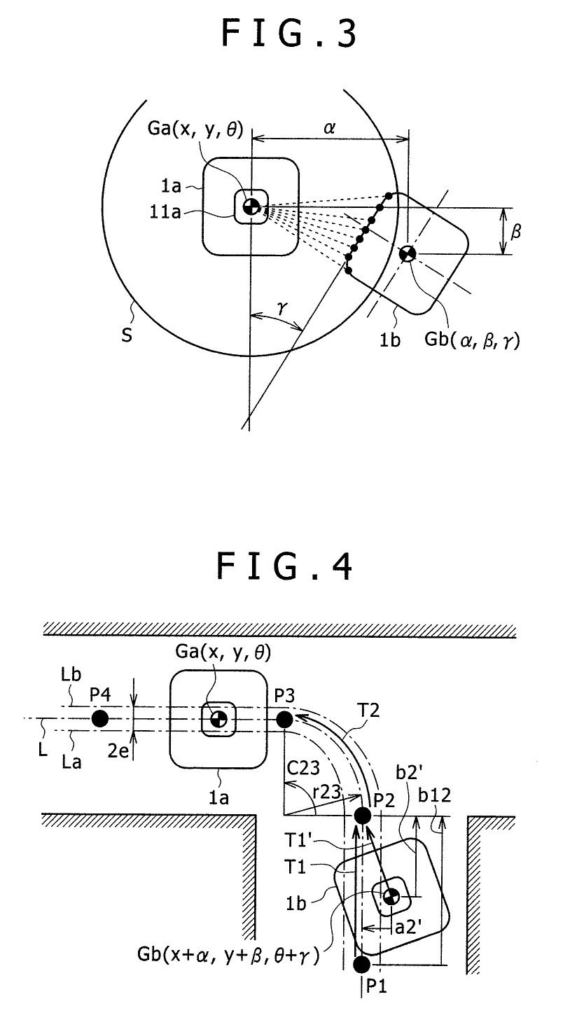

The subordinate device position recognition means 15 (15a) is used for the autonomous mobile robot 1a designated as the main device to recognize the position of the autonomous mobile robot 1b designated as a subordinate device. Here, the relative position of the autonomous mobile robot 1b (the distance and the orientation from the autonomous mobile robot 1a) is measured on the basis of the information on the ambient environment obtained by the measurement means 11a. An example of the measurement is explained in reference to FIG. 3.

The position of the center Ga of the autonomous mobile robot 1a is assumed to be represented by (x, y, θ) on the basis of the recognition result of the main device position recognition means 14a. The measurement means 11a captures one side of the subordinate autonomous mobile robot 1b and the subordinate device position recognition means 15a recognizes the autonomous mobile robot 1b from the shape pattern of the side and measures the distance (α and β) from the center Ga and the inclination γ. The relative position of the center Gb of the autonomous mobile robot 1b is expressed by (α, 62 , γ). Further, as another method, there is a method of obtaining the position of the autonomous mobile robot 1a, which is measured and recognized from the side of the autonomous mobile robot 1b by the main device position recognition means 14b of the autonomous mobile robot 1b, by the main device position recognition means 14a via the communication means 12b and the communication means 12a.

The travel planning means 16a of the autonomous mobile robot 1a designated as the main device plans the travel routes of both the autonomous mobile robots 1a and 1b on the basis of the distances of surrounding physical bodies obtained by the measurement means 11a and the positions of the autonomous mobile robots 1a and 1b.

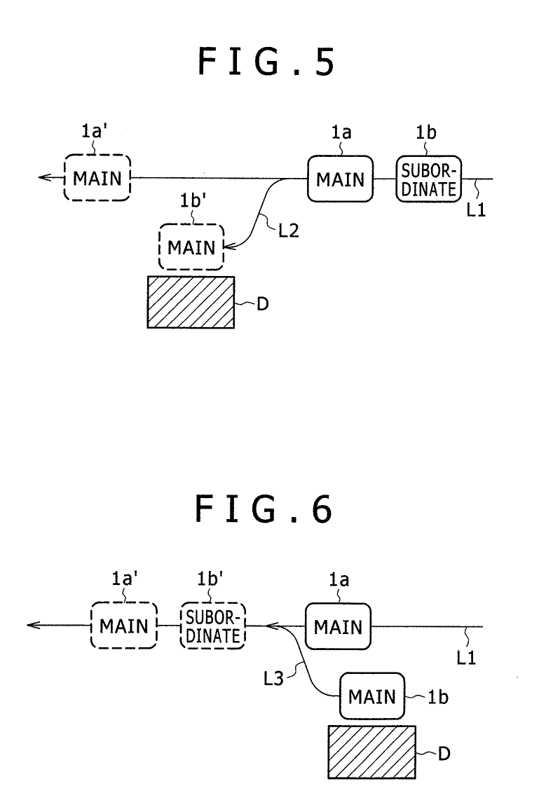

FIG. 4 is an explanatory view showing, as an example of travel control, the case where the autonomous mobile robot 1b moves through the travel nodes P1, P2, and P3 in accordance with the instructions of the autonomous mobile robot 1a designated as the main device.

Firstly, the integrative planning means 5 plans the movement through the travel nodes P1, P2, and P3 at the travel node level. As the initial movement plan (travel plan) of the autonomous mobile robot 1a, the travel planning means 16a makes a plan at a track level to apply rectilinear travel T1 (0, b12, v) from P1 to P2 and curvilinear travel T2 (r23, c23, v) from P2 to P3. The reference characters “a” and “b” represent distances, “r” a radius of rotation, “c” an angle of rotation, and “v” a traveling speed. The center of the travel route is the line L and the allowance is a prescribed error “e”.

Here, when the position (x+α, y+β, θ+γ) of the autonomous mobile robot 1b deviates from the error range La-Lb, replanning is carried out. More specifically, in FIG. 4, the rectilinear travel T1′ (a2′, b2′, v) is reassigned so as to carry out the movement from the point Gb deviated from the error range to the travel node P2 in the direction designated with the arrow.

The travel plan made by the travel planning means 16a of the autonomous mobile robot 1a designated as the main device is sent to the travel planning means 16b of the autonomous mobile robot 1b via the communication means 12. Travel control means 17b: controls a drive mechanism 18b so as to follow the travel plan; and moves the autonomous mobile robots 1 on the travel plane G.

In such a configuration as to combine plural autonomous mobile robots 1, a main device controls a subordinate device and thereby it is possible to: reduce interference such as collision between the autonomous mobile robots 1 at a corner when they travel in a convoy; and travel effectively. Further, in a travel environment where the autonomous mobile robots 1 intersect with a person such as a worker, by traveling in a convoy, it is possible to reduce the frequency of the movement of the robots and enhance the safety.

In a robot system to integrate plural autonomous mobile robots 1 and control the movement thereof, it is possible to: add a loader mechanism to load parts needed in production lines to the autonomous mobile robots 1; and convey the parts to arbitrary places by branching for example. The aspects are shown in FIGS. 5 and 6.

In FIG. 5, the autonomous mobile robot 1a acting as a main device and the autonomous mobile robot 1b acting as a subordinate device directed to the same direction travel closely in a convoy along the route L1 and parts are loaded on the autonomous mobile robot 1b. Then the autonomous mobile robot 1b: is branched from the travel route L1 to the travel route L2 on the way; and travels so as to convey the parts to a destination D (1b to 1b′). Meanwhile, the autonomous mobile robot 1a travels continuously along the travel route L1 (1a to 1a′).

Here, the autonomous mobile robot 1b: follows the instructions (control) of the autonomous mobile robot 1a until it reaches the branch; after the branch, is designated to be changed from the subordinate device to a main device by the instructions of the integrative planning means 5; generates the travel route L2 by itself; autonomously travels; and reaches the destination D (1b′).

The operations after unloading at the destination D are shown in FIG. 6. After the unloading, the end of the unloading is notified to the integrative planning means 5 by the switching operation of an operator or the like. The autonomous mobile robot 1b autonomously travels as a main device along the travel route L3 under the instructions of the integrative planning means 5 (1b). After merging on the travel route L1, the autonomous mobile robot 1b travels together with the other autonomous mobile robot (1b to 1b′).

Here, when the autonomous mobile robot 1a that has been separated at the branching exists on the travel route L1 in the vicinity of the merging point at the time of the merging, the autonomous mobile robot 1b is designated to be changed to a subordinate device having the autonomous mobile robot 1a as the main device and travels together under the instructions of the integrative planning means 5 (1a′, 1b′). When an autonomous mobile robot 1 other than the autonomous mobile robot 1a exists in the vicinity of the merging point, the autonomous mobile robot 1 is designated as a main device and the autonomous mobile robot 1b is designated to be changed to a subordinate device by the instructions of the integrative planning means 5. Thereafter, the convoy travels along the travel route L1 in accordance with the instructions of the autonomous mobile robot designated as the main device.

In this way, by changing the autonomous mobile robot designated as a subordinate device from the subordinate device to a main device at the time of branching and from the main device to the subordinate device at the time of merging, it is possible to smoothly control the operations when the autonomous mobile robot branches and merges.

Although both the robots are autonomous mobile robots in the above first embodiment, since the autonomous mobile robot 1a acting as the main device makes the travel plan of the autonomous mobile robot 1b acting as the subordinate device when they are operated in combination, the measurement means 11b, the main device position recognition means 14b, the subordinate device position recognition means 15b, and the travel planning means 16b of the autonomous mobile robot 1b acting as the subordinate device are not necessarily required.

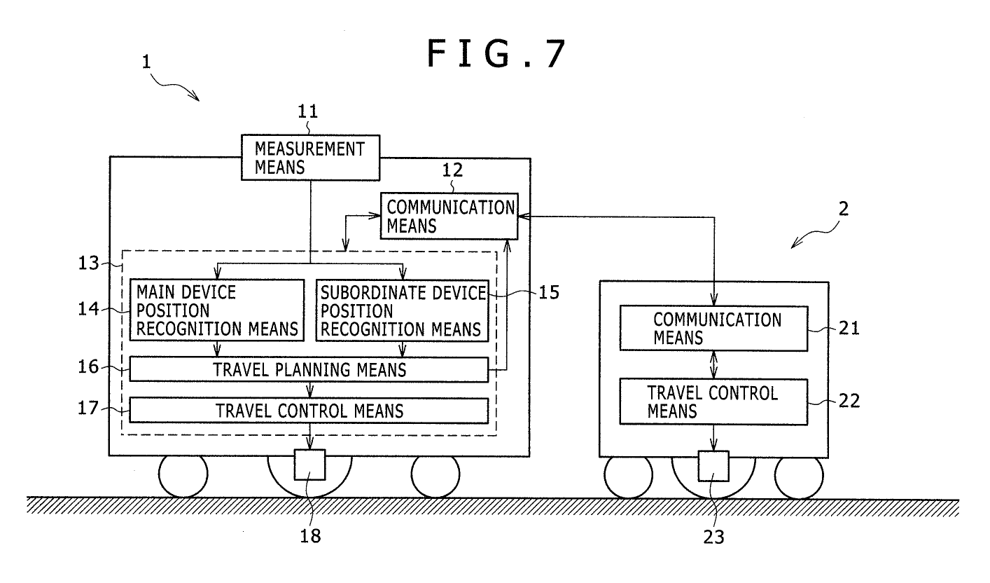

The second embodiment is shown in FIG. 7. The mobile robot 2 acting as a subordinate device in the second embodiment is simply composed of components essential for functioning exclusively as a subordinate device and hereunder referred to as a subordinate mobile robot. The constituent components of the subordinate mobile robot 2 are communication means 21, travel control means 22, and a drive mechanism 23. The functions of the components are the same as stated above and thus the explanations are omitted. The number of parts for the measurement means and others in the subordinate mobile robot 2 is smaller than that in the autonomous mobile robot 1 and hence the subordinate mobile robot 2 can be configured at a lower cost.

Further, since the subordinate mobile robot 2 has no measurement means as stated above, it is inferior in responsiveness to the change of ambient environment. For example, the measurement means 11 of the autonomous mobile robot 1 acting as the main device may undesirably have a blind spot when the subordinate mobile robot 2 approaches a suddenly pop-up human body.

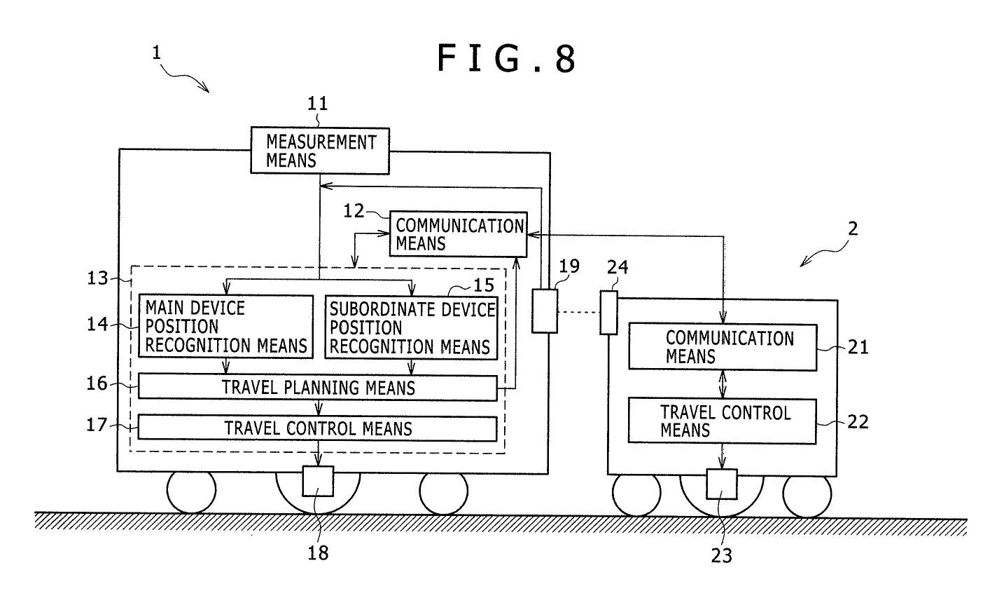

To cope with the problem, as the third embodiment shown in FIG. 8, the measurement means 11 is placed at a position on the autonomous mobile robot 1 where no blind spots are caused by the subordinate mobile robot 2, for example a vistaed position above the subordinate mobile robot 2. Then second measurement means 19 is installed on a side of the autonomous mobile robot 1 so that the subordinate mobile robot 2 may be easily detected. On this occasion, the second measurement means 19 measures an object on the side at a shorter distance than the case of the measurement means 11 and hence can use a less-expensive sensor. It is possible to eliminate a blind spot by the configuration and further improve the reliability of measurement by the duplication of the measurement means.

Further, the subordinate mobile robot 2 is provided with identification means 24 measured by the second measurement means 19 in FIG. 8. The identification means 24: improves the reliability of the measurement by the second measurement means 19 and recognition by the subordinate device position recognition means 15; and can attach the device number of the subordinate mobile robot 2 to the identification means 24, more specifically can show the device number with a two-dimensional bar code or a wireless ID tag.

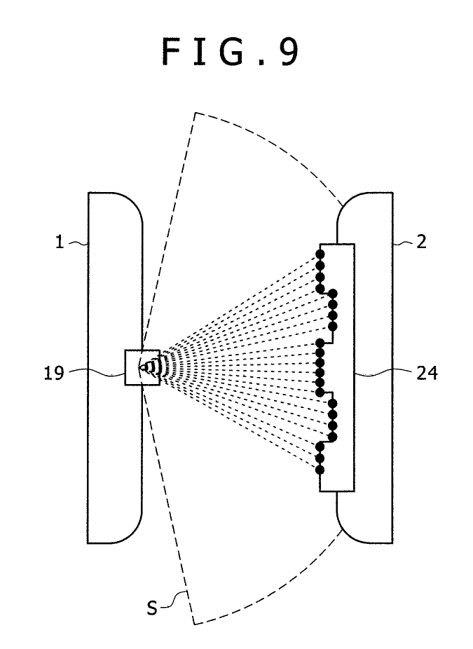

FIG. 9 shows a case where a hubbly-shaped member is attached as another identification means 24 to the subordinate mobile robot 2 and a laser range finder is used as the second measurement means 19. The hubbly shape of the identification means 24 is measured and recognized by the distance measurement function of laser beam scanning and thereby the position of the subordinate mobile robot 2 and the device number are recognized.

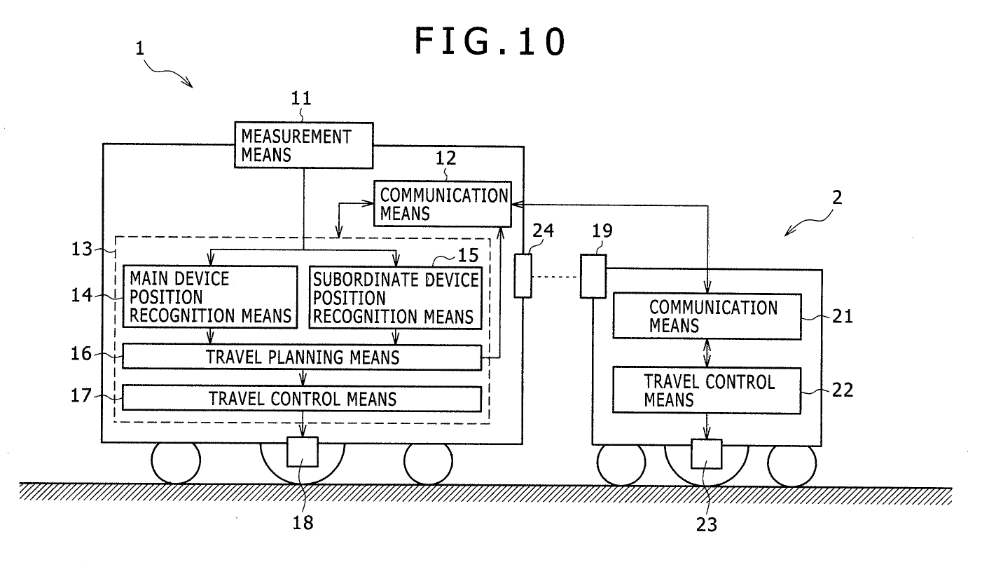

Further, FIG. 10 shows, as the fourth embodiment, a case where identification means 24 is attached to an autonomous mobile robot 1 and the second measurement means 19 is attached to the subordinate mobile robot 2 inversely with the third embodiment. On this occasion, the second measurement means 19 measures the autonomous mobile robot 1, the device number of the subordinate mobile robot 2 itself is added to the measurement data, and the data are transmitted to the autonomous mobile robot 1 via the communication means 21.

The subordinate device position recognition means 15 recognizes the device number of the subordinate mobile robot 2 and the relative position of the subordinate mobile robot 2 to the autonomous mobile robot 1 on the basis of the device number and the identification means 24 of the main device 1 measured by the second measurement means 19. In this way, it is possible to install the identification means 24 and the second measurement means 19 inversely with the third embodiment.

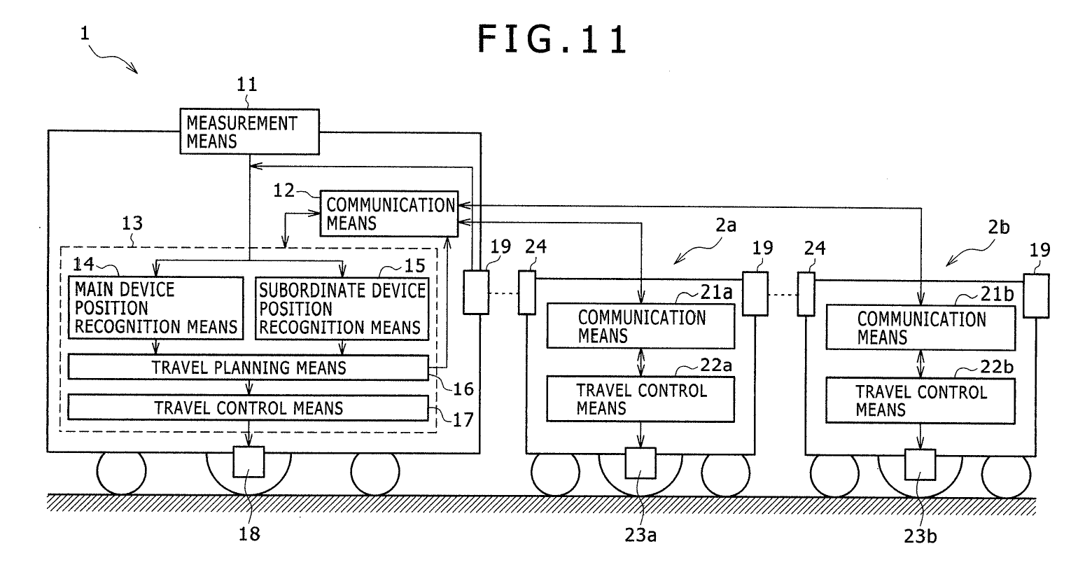

Further, it is possible to control plural subordinate mobile robots 2a and 2b by introducing the device numbers of mobile robots like the fifth embodiment shown in FIG. 11. Here, the second measurement means 19 are installed on the side of the autonomous mobile robot 1 and on the sides of the plural subordinate mobile robots 2a and 2b respectively and the identification means 24 are installed on the other sides of the subordinate mobile robots 2a and 2b. The identification means 24 of the subordinate mobile robot 2a is measured by the second measurement means 19 of the autonomous mobile robot 1 and the identification means 24 of the subordinate mobile robot 2b is measured by the second measurement means 19 of the subordinate mobile robot 2a.

The data obtained by the measurement are accumulated in the subordinate device position recognition means 15 of the autonomous mobile robot 1 and the positions of the plural subordinate mobile robots 2 are recognized. Then on the basis of the recognition, the travel plans of the plural subordinate mobile robots 2 are made by the travel planning means 16 and the planned travel routes are transmitted to the subordinate mobile robots 2a and 2b respectively via the communication means 12, 21a, and 21b.

By controlling drive mechanisms 23a and 23b with the travel control means 22a and 22b respectively, it is possible to cooperatively move the autonomous mobile robot 1 acting as the main device and the plural subordinate mobile robots 2 as a whole.

In FIG. 11, the autonomous mobile robot 1 is at the forefront in the configuration where plural robots are aligned in a row. This is because ambient environment changing in accordance with movement can be measured effectively when the autonomous mobile robot 1 is at the forefront in the traveling direction. Further, in the system configured with the plural robots, the number of the subordinate mobile robots 2 configurable at a low cost increases and hence the logistical cost can be reduced as the whole system.

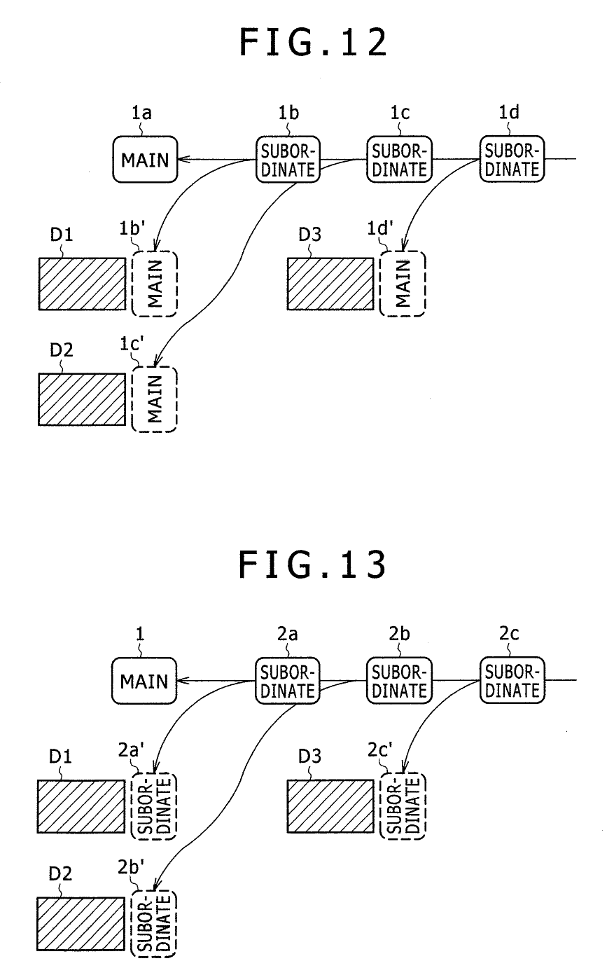

The configuration of the cooperative operations of a main mobile robot and plural subordinate mobile robots is clarified in the aforementioned fifth embodiment. A possible pattern of cooperative operations of plural robots in the actual operations is that: a main mobile robot in tandem takes plural subordinate robots with the main mobile robot to a workplace as shown in FIG. 5; and, after arriving at the workplace, the plural subordinate robots 1b to 1d are distributed at arbitrary places such as destinations D1 to D3 respectively, after operations, gather together at the place where the main mobile robot 1a is stationed, and move toward a subsequent workplace as shown in FIG. 12.

Such operational control can be carried out by: configuring the subordinate mobile robots 1b, 1c, and 1d similarly to the main mobile robot 1a described in the first embodiment; and applying the operations shown in FIGS. 5 and 6 wherein, after arrival at a workplace, the subordinate mobile robots 1b, 1c, and 1d are controlled by the integrative planning means 5 and used as independent main mobile robots. That is, the subordinate mobile robots 1b, 1c, and 1d may be operated by being given travel routes toward the destinations D1 to D3 respectively by the integrative planning means 5 after the arrival at the workplace.

Such operations are effective in improving work efficiency by parallelizing the operations. A problem thereof however is the equipment cost of such many subordinate mobile robots 1b, 1c, and 1d. As a means for solving the problem, a configuration of the subordinate mobile robot 2 that is remotely controlled with the main mobile robot 1 and can reduce the cost with a minimum necessary system structure is proposed in the second embodiment.

Operations in the case where the system is applied to different work at a workplace as shown in FIG. 12 are shown in FIG. 13. In the case of the operations: the subordinate mobile robots 2a to 2c are guided by the main mobile robot 1 to a workplace in tandem; and the main mobile robot 1 remotely maneuvers the subordinate mobile robots 2a to 2c toward the destinations D1 to D3 after the arrival at the workplace and further maneuvers them so that the subordinate mobile robots 2a to 2c may gather together after the work. The preconditions for realizing the operations are that the main mobile robot 1 can remotely maneuver the subordinate mobile robots 2a to 2c by continuously giving travel commands to the travel control means 22 in the subordinate mobile robots 2a to 2c on the basis of the travel plans of the subordinate mobile robots 2a to 2c determined by the travel planning means 16 in the main mobile robot 1 while all the positions and orientations of the subordinate mobile robots 2a to 2c are captured constantly by the measurement means 11.

The above system: has an effect of keeping the system cost low; but inversely has the disadvantages that the continuous remote control of the subordinate mobile robots 2a to 2c cannot be carried out, the separate operations are interrupted, and thus the environmental conditions of the separate operations are restricted considerably when the subordinate mobile robots 2a to 2c are located in a range not visible with the measurement means 11 in the main mobile robot 1, for example when a barrier exists between them.

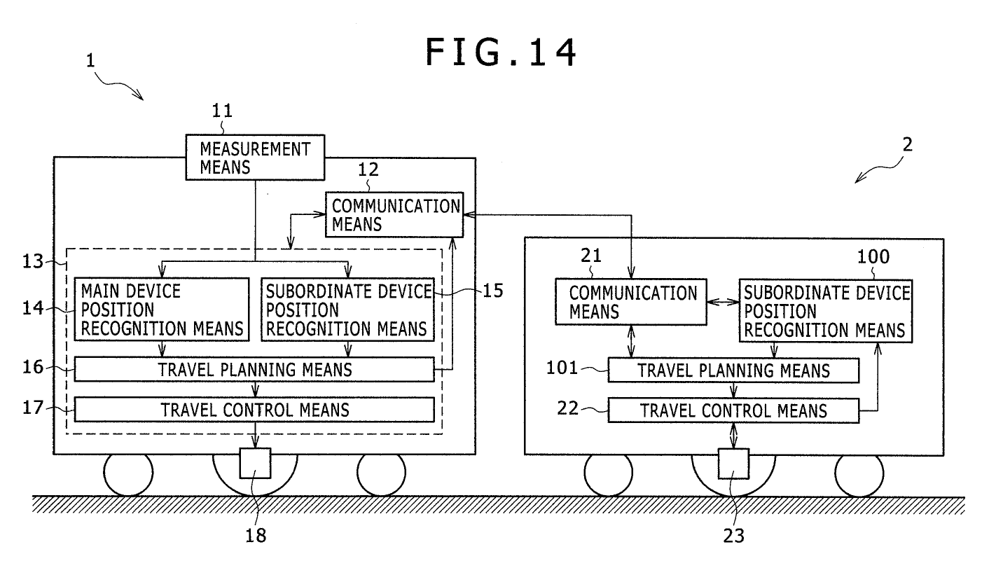

In order to solve the above problems and reduce the system cost at the same time, the sixth embodiment sown in FIG. 14 is proposed. In the present embodiment, the system has a configuration wherein a subordinate device position recognition means 100 and a travel planning means 101 are added to the structure of the subordinate mobile robot 2 according to the second embodiment shown in FIG. 7.

In the present configuration, the travel control means 22 acquires information on a cumulative moving distance and a moving orientation in order to operate traveling with the drive mechanism 23. In the case of a differential drive mechanism for example, the numbers of the revolutions of the right and left drive wheels are measured with an encoder, the cumulative moving distance is estimated on the basis of the cumulative value counted with the encoder, and the moving orientation is estimated on the basis of the difference between the numbers of the revolutions of the right and left drive wheels or with a separately attached gyrosensor or the like.

The subordinate device position recognition means 100 estimates the position and the moving orientation of the subordinate mobile robot 2 itself on a map identical to the map acquired by the main mobile robot 1 on the basis of the information on the cumulative moving distance and the moving orientation acquired by the travel control means 22 and the predetermined initial travel conditions, namely the initial position and the initial orientation.

The travel planning means 101 receives individual travel plan data of the subordinate mobile robot 2 itself from the travel planning means 16 in the main mobile robot 1 and autonomously runs the subordinate mobile robot 2 on the basis of the self-position information acquired by the subordinate device position recognition means 100.

The main mobile robot 1, when it captures the subordinate mobile robot 2 by the measurement means 11, supplies data on the position and the moving orientation of the subordinate mobile robot 2 and time data on the time when the subordinate mobile robot 2 is captured through the communication means 12. The subordinate device position recognition means 100 receives the data on the position and the moving orientation of the subordinate mobile robot 2 through the communication means 21 and compensates the values of the position and the moving orientation of the subordinate mobile robot 2.

In the present embodiment, the position of the subordinate mobile robot 2 itself is estimated on the basis of the cumulative information acquired from the travel control means 22 and hence, in the case of long distance traveling or long time traveling, the accuracy in the estimation of the self-position deteriorates considerably due to slip in the drive mechanism 23, accumulation of measurement errors accompanying the increase of measurement time, or the like.

In order to solve the above problem, the subordinate device position recognition means 100 cancels the aforementioned cumulative error by using the data on the position and the moving orientation of the subordinate mobile robot 2 supplied from the main mobile robot 1 at a certain time as the true values in the initialization conditions. The cancellation is not always necessary and the increase of the error in the estimation of the self-position caused by the subordinate mobile robot 2 itself can be limited within a finite value even when the acquisition of the subordinate mobile robot 2 by the main mobile robot 1 is intermittent.

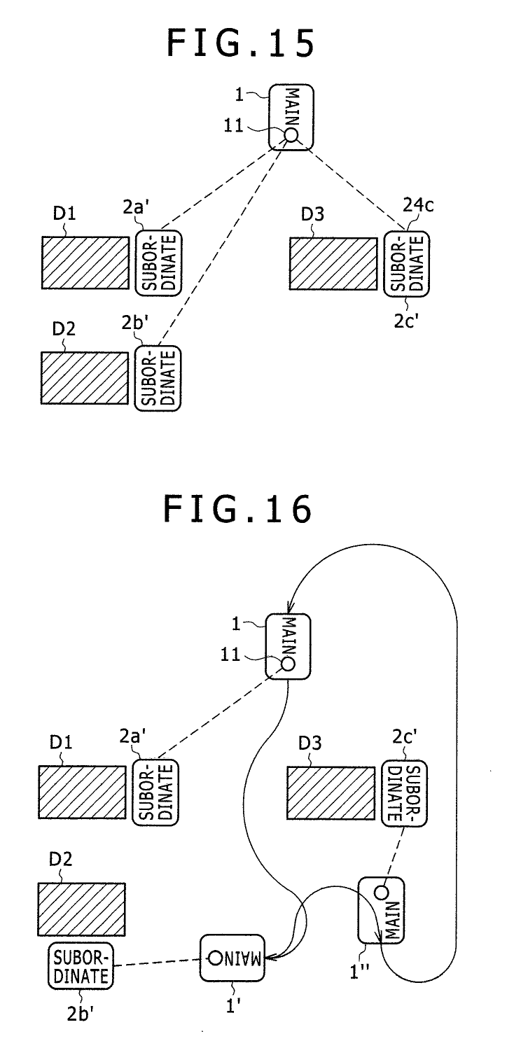

Examples of the operations in the present configuration are explained in reference to FIGS. 15 and 16. In the operations shown in FIG. 15, the main mobile robot 1 measures the positions and the moving orientations of the subordinate mobile robots 2a to 2c existing in the region visible by the installed measurement means 11 and supplies the data on the positions and the moving orientations to the subordinate device position recognition means 100 in the subordinate mobile robots 2a to 2c respectively, the subordinate mobile robots 2a to 2c correct the errors of the self-positions respectively, and thus the traveling accuracy is maintained. The subordinate mobile robots 2a to 2c are identified respectively by: using estimated positions of the subordinate mobile robots 2a to 2c acquired by the subordinate device position recognition means 15 in the main mobile robot 1; and searching the outer shapes of the subordinate mobile robots 2a to 2c.

In the operations shown in FIG. 16, the main mobile robot 1: travels cyclically to the vicinities of the subordinate mobile robots 2a to 2c; and searches the subordinate mobile robots 2a to 2c respectively. By so doing, it is possible to surely recognize the positions of the subordinate mobile robots 2a to 2c that have been out of vision and invisible.

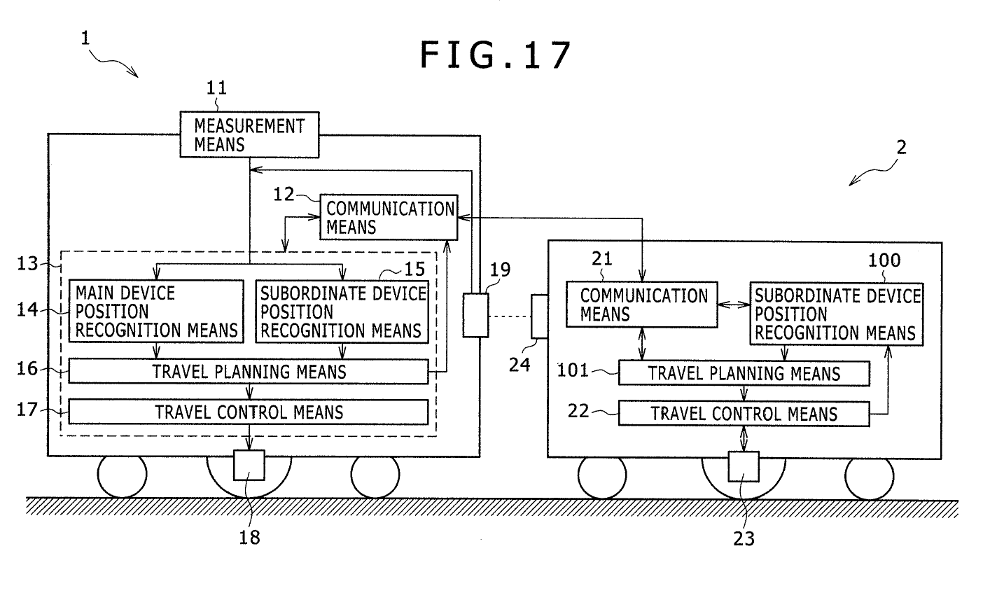

In the operations shown in FIGS. 16 and 17, the explanations have been made on the premise that the subordinate mobile robots 2a to 2c are stationed at certain places. It is obvious however that it is possible to improve the traveling accuracy of the subordinate mobile robots 2a to 2c likewise even in the state where the subordinate mobile robots 2a to 2c travel individually.

By the present configuration, highly-accurate autonomous traveling can be realized with a low-cost subordinate mobile robot and the economic effect is large particularly when many subordinate mobile robots are operated in parallel.

In the sixth embodiment, the measurement means 11 is used for capturing subordinate mobile robots 2. On this occasion, when plural subordinate mobile robots 2 are operated as shown in the third embodiment, the possibility that the region visible with the measurement means 11 is shielded increases. Further, in the sixth embodiment, the subordinate mobile robots 2a to 2c are estimated and identified on the basis of the estimated positions respectively and thus it is possible to cause misidentification, for example, in the case where the subordinate mobile robots 2a to 2c travel closely to each other or another case.

In the configuration according to the seventh embodiment shown in FIG. 17, the main mobile robot 1 is provided with second measurement means 19 and the subordinate mobile robot 2 is provided with identification means 24 in the same way as the third embodiment. By the configuration, in the operation example shown in FIG. 16 and 17, the accuracy in capturing the positions of the subordinate mobile robots 2a to 2c improves and misidentification of respective robots is avoided by detecting the identification means 24 uniquely allocated respectively to the subordinate mobile robots 2a to 2c.

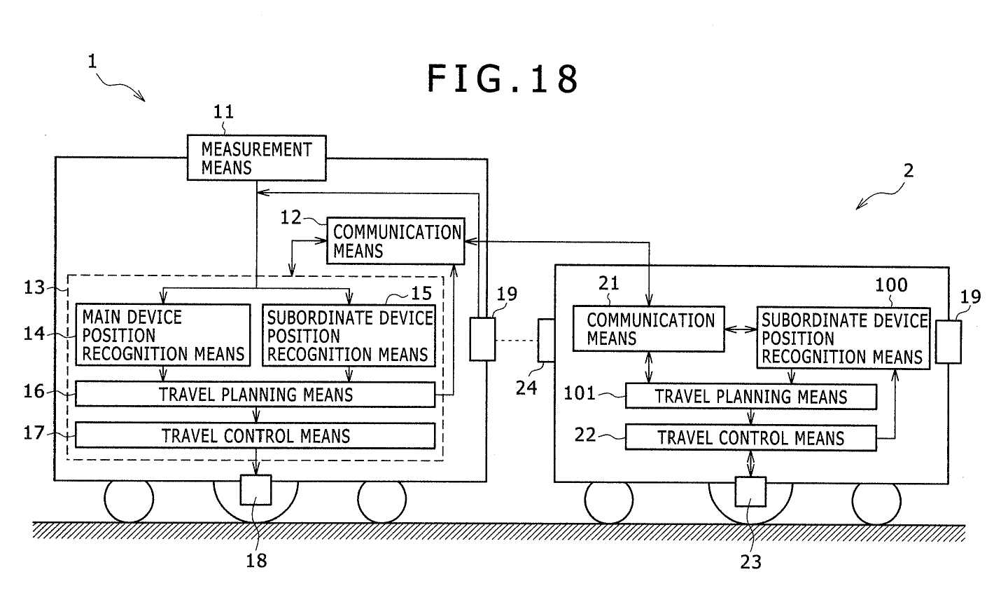

In the configuration according to the eighth embodiment shown in FIG. 18, the subordinate mobile robot 2 in the seventh embodiment is provided with another second measurement means 19 and the data on the position and the orientation of another subordinate mobile robot 2 acquired thereby are sent to the main mobile robot 1.

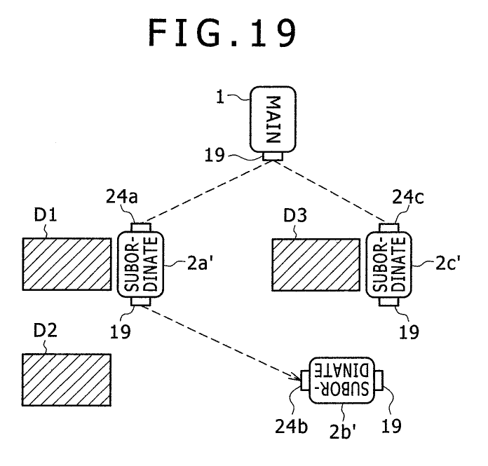

By the present configuration, like the operation example shown in FIG. 19, the position and the orientation of the subordinate mobile robot 2b invisible from the main mobile robot 1 can be relatively measured with the subordinate mobile robot 2a the relative position of which can be measured with the main mobile robot 1 and thus the position and the orientation of the subordinate mobile robot 2b can be measured from the main mobile robot 1. Consequently, in the configuration, the positions and the orientations of the subordinate mobile robots can be recognized with higher degrees of accuracy and provability than the case of the seventh embodiment.

What is claimed is:

1. An autonomous mobile robot system having plural mobile robots and integrative planning means to plan the moving zone of the plural mobile robots, wherein:
the integrative planning means is installed on the plural mobile robots including a main mobile robot to travel autonomously and a subordinate mobile robot to travel on the basis of the instructions of the main mobile robot; and
each of the plural mobile robots is provided with, at least, measurement means to measure the situation of ambient environment, communication means to communicate between the integrative planning means and the other mobile robot, main device position recognition means to recognize the position of the mobile robot, subordinate device position recognition means to recognize the position of the other mobile robot, travel planning means to plan travel routes of the mobile robot and the other mobile robot, and travel control means to control a drive mechanism in accordance with the travel planning means.

2. An autonomous mobile robot system having plural mobile robots and integrative planning means to plan the moving zone of the plural mobile robots,
wherein: the plural mobile robots include a main mobile robot to travel autonomously and a subordinate mobile robot to travel on the basis of the instructions of the main mobile robot;
the main mobile robot is provided with, at least, measurement means to measure the situation of ambient environment, communication means to communicate between the integrative planning means and the subordinate mobile robot, main device position recognition means to recognize the position of the main mobile robot, subordinate device position recognition means to recognize the position of the subordinate mobile robot, travel planning means to plan travel routes of the main mobile robot and the subordinate mobile robot, and travel control means to control a drive mechanism in accordance with the travel planning means; and
the subordinate mobile robot is provided with, at least, communication means to communicate between the integrative planning means and the main mobile robot, and travel control means to control a drive mechanism in accordance with the travel planning means of the main mobile robot.

3. An autonomous mobile robot system having plural mobile robots and integrative planning means to plan the moving zone of the plural mobile robots,
wherein: the integrative planning means is installed on the plural mobile robots including a main mobile robot to travel autonomously and a subordinate mobile robot to cooperatively travel on the basis of the instructions of the main mobile robot;
each of the plural mobile robots is provided with measurement means to measure the situation of ambient environment, communication means to communicate between the integrative planning means and the other mobile robot, main device position recognition means to recognize the position of the main mobile robot, subordinate device position recognition means to recognize the position of the subordinate mobile robot, travel planning means to plan travel routes of the main mobile robot and the subordinate mobile robot, and travel control means to control a drive mechanism in accordance with the travel planning means; and
the subordinate mobile robot is designated to be changed to a main mobile robot by the instructions of the integrative planning means and travels autonomously when the subordinate mobile robot is separated from the interlocked main mobile robot and travels.

4. An autonomous mobile robot system having plural mobile robots and integrative planning means to plan the moving zone of the plural mobile robots,
wherein: the integrative planning means is installed on the plural mobile robots including a main mobile robot to travel autonomously and a subordinate mobile robot to travel on the basis of the instructions of the main mobile robot;
each of the plural mobile robots is provided with measurement means to measure the situation of ambient environment, communication means to communicate between the integrative planning means and the other mobile robot, main device position recognition means to recognize the position of the main mobile robot, subordinate device position recognition means to recognize the position of the subordinate mobile robot, travel planning means to plan travel routes of the main mobile robot and the subordinate mobile robot, and travel control means to control a drive mechanism in accordance with the travel planning means; and
when the travel route along which the main mobile robot travels merges with another travel route, the main mobile robot is designated to be changed to a subordinate mobile robot by the instructions of the integrative planning means and cooperatively travels after merger by the instructions of another main mobile robot located on the other travel route.

5. The autonomous mobile robot system according to claim 1, wherein the mobile robot is provided with a plurality of measurement means to measure the situation of ambient environment.

6. The autonomous mobile robot system according to claim 2, wherein the mobile robot is provided with a plurality of measurement means to measure the situation of ambient environment.

7. The autonomous mobile robot system according to claim 3, wherein the mobile robot is provided with a plurality of measurement means to measure the situation of ambient environment.

8. The autonomous mobile robot system according to claim 4, wherein the mobile robot is provided with a plurality of measurement means to measure the situation of ambient environment.

9. The autonomous mobile robot system according to claim 1,
wherein: the main mobile robot is provided with a plurality of measurement means to measure the situation of ambient environment; and
the subordinate mobile robot is provided with identification means to show a device number recognized by the measurement means.

10. The autonomous mobile robot system according to claim 2,
wherein: the main mobile robot is provided with a plurality of measurement means to measure the situation of ambient environment; and
the subordinate mobile robot is provided with identification means to show a device number recognized by the measurement means.

11. The autonomous mobile robot system according to claim 3,
wherein: the main mobile robot is provided with a plurality of measurement means to measure the situation of ambient environment; and
the subordinate mobile robot is provided with identification means to show a device number recognized by the measurement means.

12. The autonomous mobile robot system according to claim 4,
wherein: the main mobile robot is provided with a plurality of measurement means to measure the situation of ambient environment; and
the subordinate mobile robot is provided with identification means to show a device number recognized by the measurement means.

13. The autonomous mobile robot system according to claim 1,
wherein: the main mobile robot is provided with a plurality of measurement means to measure the situation of ambient environment; and
the subordinate mobile robot is provided with measurement means to measure at least a kind of the situation of ambient environment and identification means to show a device number recognized by the measurement means of the main mobile robot.

14. The autonomous mobile robot system according to claim 2,
wherein: the main mobile robot is provided with a plurality of measurement means to measure the situation of ambient environment; and
the subordinate mobile robot is provided with measurement means to measure at least a kind of the situation of ambient environment and identification means to show a device number recognized by the measurement means of the main mobile robot.

15. The autonomous mobile robot system according to claim 3,
wherein: the main mobile robot is provided with a plurality of measurement means to measure the situation of ambient environment; and
the subordinate mobile robot is provided with measurement means to measure at least a kind of the situation of ambient environment and identification means to show a device number recognized by the measurement means of the main mobile robot.

16. The autonomous mobile robot system according to claim 4,
wherein: the main mobile robot is provided with a plurality of measurement means to measure the situation of ambient environment; and
the subordinate mobile robot is provided with measurement means to measure at least a kind of the situation of ambient environment and identification means to show a device number recognized by the measurement means of the main mobile robot.

17. The autonomous mobile robot system according to claim 1, wherein at least one of the measurement means is measurement means to measure the distance from the ambient environment in the form of distribution by scanning.

18. The autonomous mobile robot system according to claim 2, wherein at least one of the measurement means is measurement means to measure the distance from the ambient environment in the form of distribution by scanning.

19. The autonomous mobile robot system according to claim 3, wherein at least one of the measurement means is measurement means to measure the distance from the ambient environment in the form of distribution by scanning.

20. The autonomous mobile robot system according to claim 4, wherein at least one of the measurement means is measurement means to measure the distance from the ambient environment in the form of distribution by scanning.

21. The autonomous mobile robot according to claim 5, wherein at least one of the measurement means is measurement means to measure the distance from ambient environment in the form of distribution by scanning.

22. The autonomous mobile robot according to claim 6, wherein at least one of the measurement means is measurement means to measure the distance from ambient environment in the form of distribution by scanning.

23. The autonomous mobile robot according to claim 7, wherein at least one of the measurement means is measurement means to measure the distance from ambient environment in the form of distribution by scanning.

24. The autonomous mobile robot according to claim 8, wherein at least one of the measurement means is measurement means to measure the distance from ambient environment in the form of distribution by scanning.

25. The autonomous mobile robot according to claim 9, wherein at least one of the measurement means is measurement means to measure the distance from ambient environment in the form of distribution by scanning.

26. The autonomous mobile robot according to claim 10, wherein at least one of the measurement means is measurement means to measure the distance from ambient environment in the form of distribution by scanning.

27. The autonomous mobile robot according to claim 11, wherein at least one of the measurement means is measurement means to measure the distance from ambient environment in the form of distribution by scanning.

28. The autonomous mobile robot according to claim 12, wherein at least one of the measurement means is measurement means to measure the distance from ambient environment in the form of distribution by scanning.

29. The autonomous mobile robot according to claim 13, wherein at least one of the measurement means is measurement means to measure the distance from ambient environment in the form of distribution by scanning.

30. The autonomous mobile robot according to claim 14, wherein at least one of the measurement means is measurement means to measure the distance from ambient environment in the form of distribution by scanning.

31. The autonomous mobile robot according to claim 15, wherein at least one of the measurement means is measurement means to measure the distance from ambient environment in the form of distribution by scanning.

32. The autonomous mobile robot according to claim 16, wherein at least one of the measurement means is measurement means to measure the distance from ambient environment in the form of distribution by scanning.

33. The autonomous mobile robot system according to claim 1,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

34. The autonomous mobile robot system according to claim 2,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

35. The autonomous mobile robot system according to claim 3,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

36. The autonomous mobile robot system according to claim 4,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

37. The autonomous mobile robot system according to claim 5,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

38. The autonomous mobile robot system according to claim 6,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

39. The autonomous mobile robot system according to claim 7,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

40. The autonomous mobile robot system according to claim 8,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

41. The autonomous mobile robot system according to claim 9,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

42. The autonomous mobile robot system according to claim 10,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

43. The autonomous mobile robot system according to claim 11,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

44. The autonomous mobile robot system according to claim 12,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

45. The autonomous mobile robot system according to claim 13,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

46. The autonomous mobile robot system according to claim 14,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

47. The autonomous mobile robot system according to claim 15,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

48. The autonomous mobile robot system according to claim 16,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

49. The autonomous mobile robot system according to claim 17,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

50. The autonomous mobile robot system according to claim 18,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

51. The autonomous mobile robot system according to claim 19,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

52. The autonomous mobile robot system according to claim 20,
wherein: the subordinate device position recognition means of the main mobile robot recognizes the positions of the plural subordinate mobile robots; and
the travel planning means of the main mobile robot is travel planning means to plan the travel routes of the plural subordinate mobile robots.

53. A method for controlling plural autonomous mobile robots by integrative planning means to plan the moving zone of the plural mobile robots,
wherein: the integrative planning means designates the plural mobile robots as a main mobile robot to travel autonomously and a subordinate mobile robot to travel on the basis of the instructions of the main mobile robot;
each of the plural mobile robots recognizes the positions of the mobile robot and the other mobile robot by measuring the situation of ambient environment and plans the travel routes of the mobile robot and the other mobile robot; and
the main and subordinate mobile robots cooperatively travel along the travel routes on the basis of the instructions of the main mobile robot designated by the integrative planning means.

54. A method for controlling plural autonomous mobile robots by integrative planning means to plan the moving zone of the plural mobile robots,
wherein: the plural mobile robots include a main mobile robot to travel autonomously and a subordinate mobile robot to travel on the basis of the instructions of the main mobile robot;
the main mobile robot recognizes the positions of the main mobile robot and the subordinate mobile robot by measuring the situation of ambient environment and plans the travel routes of the main mobile robot and the subordinate mobile robot; and
the subordinate mobile robot travels cooperatively with the main mobile robot along the travel routes planned on the basis of the instructions of the main mobile robot.

55. A method for controlling plural autonomous mobile robots by integrative planning means to plan the moving zone of the plural mobile robots,
wherein: the integrative planning means designates the plural mobile robots as a main mobile robot to travel autonomously and a subordinate mobile robot to travel on the basis of the instructions of the main mobile robot;
each of the plural mobile robots recognizes the positions of the mobile robot and the other mobile robot by measuring the situation of ambient environment and plans the travel routes of the mobile robot and the other mobile robot;
the main and subordinate mobile robots cooperatively travel along the travel routes on the basis of the instructions of the main mobile robot designated by the integrative planning means; and
when the subordinate mobile robot is separated from the cooperative travel and travels, the subordinate mobile robot is designated to be changed to a main mobile robot and travels autonomously by the instructions of the integrative planning means.
